(19) United States
(12) Patent Application Publication
(10) Pub. No.: US 2023/0044470 A1
(43) Pub. Date: Feb. 9, 2023

(54) Systems and Methods for Detecting Novel Behaviors Using Model Sharing

(71) Applicant: Anurag Singla, Cupertino, CA (US)

(72) Inventor: Anurag Singla, Cupertino, CA (US)

(21) Appl. No.: 17/397,568

(22) Filed: Aug. 9, 2021

(51) Int. Cl. H04L 29/06; G06K 9/62; G06N 20/00

(52) U.S. Cl. CPC H04L 63/1425; H04L 63/1416; H04L 63/20; G06K 9/6256; G06N 20/00

(57) ABSTRACT

According to an example, an autonomous normal and novel behavior sharing apparatus may receive one or more novel behavior baseline models and one or more normal behavior baseline models from a first entity for sharing with a second entity and a subset of other entities; share the received models with the second entity and a subset of other entities; receive one or more novel behavior baseline models and one or more normal behavior baseline models from other entities for sharing with the first entity and a subset of other entities; share the received models with the first entity and subset of other entities; receive effectiveness factor of the shared models from the entities that received these models; score the models based on effectiveness factor received from a plurality of entities; prioritize sharing of the models based on their score.

### BACKGROUND

An organization or an entity typically has a large number of network devices (including but not limited to computers, printers, firewalls, web proxies, Intrusion Detection Systems, Intrusion Prevention Systems, Data Leakage Prevention Systems, Badge Systems) and software applications. Organizations typically use machine learning based novel behavior detection systems that can detect novel behaviors from these events. Detecting novel behaviors with high fidelity can help organizations in determining new or unexpected behaviors that may be potentially malicious. These organizations can benefit by sharing and receiving normal and novel behavior baseline models, utilized by machine learning based systems, with other entities. Sharing and receiving models from other entities can enable novel behavior detection systems to suppress false positive detections of novel behavior events as well as detect novel behavior events using models trained on other entities network, application, user and device events. This allows multiple organizations to improve detection of novel behavior events in their environment utilizing the models trained on other organizations' events.

### BRIEF DESCRIPTION OF DRAWINGS

Features of the present disclosure are illustrated by way of example and not limited in the following figure(s), in which like numerals indicate like elements, in which:

FIG. 1 illustrates an architecture of a novel behavior detection apparatus, according to an example of the present disclosure;

FIG. 2 illustrates an autonomous normal and novel behavior sharing apparatus, according to an example of the present disclosure;

FIG. 3 illustrates an autonomous novel behavior detection with model sharing apparatus, according to an example of the present disclosure;

FIG. 4 illustrates a method for suppressing a novel behavior event based on the determination that a novel behavior event is not detected novel by a threshold number of normal behavior baseline model received from other entities, according to an example of the present disclosure;

FIG. 5 illustrates a method for evaluating network, user, device and application activity events by novel behavior baseline models received from other entities for determining if the event is novel behavior event, according to an example of the present disclosure;

FIG. 6 illustrates a method for determining the decrease in the transformation scale of a subset of fields of the network, user, device and application activity events to be processed by neural networks based models in a novel behavior detection apparatus, according to an example of the present disclosure;

FIG. 7 illustrates a method for determining the increase in the transformation scale of a subset of fields of the network, user, device and application activity events to be processed by neural networks based models in a novel behavior detection apparatus, according to an example of the present disclosure;

FIG. 8 illustrates a method for determining the decrease in the weights of a subset of fields in the loss function used to calculate deviation of reconstructed network, user, device and application activity events from original network, user, device and application activity events in a novel behavior detection apparatus, according to an example of the present disclosure;

FIG. 9 illustrates a method for determining the increase in the weights of a subset of fields in the loss function used to calculate deviation of reconstructed network, user, device and application activity events from original network, user, device and application activity events in a novel behavior detection apparatus, according to an example of the present disclosure;

FIG. 10 illustrates a computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Organizations typically keep logs of network, user, device and application activities for forensic analysis. These logs can be utilized by systems to detect potentially malicious activities.

According to examples, an autonomous novel behavior detection apparatus and a method for detecting novel network, user, device or application behavior are disclosed herein. For the apparatus and method disclosed herein, the network, user, device and application event logs may be generated by any of the systems involved in the interaction. These event logs typically contain information about the entities and resources involved in the event, type of actions taken and additional details about the interaction. The apparatus and method disclosed herein may learn the existing network, user, device and application behaviors from these logs, and evaluate subsequent event logs against learned behaviors and identify novel behaviors. These identified novel behaviors are learned again to be able to identify new behaviors that are similar to behaviors identified as novel in the past. The novel behaviors that are not identical or similar to already identified novel behaviors are surfaced as novel behaviors. These novel behaviors are clustered together in a multi-dimensional space to combine them into summarized novel behaviors that a user can review. These novel behaviors may indicate a potentially malicious activity or match an expected shift in behavior.

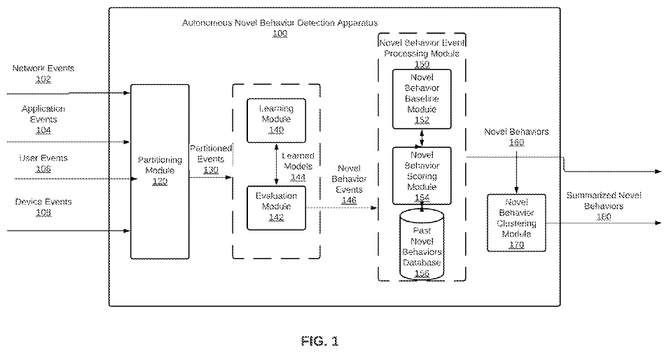

FIG. 1 illustrates an Autonomous Novel Behavior Detection Apparatus 100 (hereinafter also referred to as “apparatus 100”), according to an example of the present disclosure. Referring to FIG. 1, the apparatus 100 is depicted as including a Partition module 120 to partition the incoming events (including Network Events 102, Application Events 104, User Events 106, Device Events 108) to be processed by multiple models. Partitioning module contains multiple handlers that split the incoming events into a plurality of partitions. The partitioning is performed based on the information in the event (E.g. user information, device information, application etc.) Partition module 120 can adjust the number of partitions by splitting an existing partition into multiple partitions if a partition is receiving a large percentage of events or merging a plurality of partitions into a single partition if those partitions received a very small subset of events. The partition module also normalizes the values of various information fields in the event by firstly converting non-numeric values to numeric values utilizing transformation functions (including hashing) and adjusting the numeric values so that the values in different information fields are comparable in size.

Learning Module 140 receives the partitioned events 130 and utilizes the information in these events to augment the learned behavior by including the newly received information. Learning Module 140 contains a plurality of neural network learning models per partition split created by Partition Module 120. The models in Learning Module 140 use a combination of neural networks (including Auto Encoders, Sparse Auto Encoders, Denoising Auto Encoders, Functional Models, Variational AutoEncoders, Sequential neural networks). Multiple models are utilized to determine the deviation of new events from the learned behavior. Learning Module 140 periodically updates Evaluation Module 142 by providing updated instances of learned models. Evaluation Module 142 uses the models provided by Learning Module 140 to evaluate Partitioned Events 130. Learning Module 140 provides plurality of Learned Models 144 at a varying time interval to Evaluation Module 142, so that an adversary cannot take advantage of the predictable staleness of models in Evaluation Module 142. Staleness could allow an adversary to perform a decoy attack, flooding the system with anomalous events before conducting a real attack.

Learning Module 140 also includes certain models that skip varying percentages of events. The percentages of events to be skipped as well as the events that need to be skipped are determined randomly using various probability distributions (including normal, Gaussian etc.) by dropping random samples of events from a subset of the models in the Learning Module 140, the adversaries are prevented from intentionally training the system by purposely performing certain activity in a slow and less harmful way before conducting real attack.

Evaluation Module 142 utilizes neural network models to detect if an evaluated Partitioned Event 130 deviates from the learned behavior of the events by the evaluating model. If the behavior deviates more than a threshold then the event is marked as a Novel Behavior Event and is sent to Novel Behavior Event Processing Module 150. The threshold for determining novel behavior events can be fixed or flexible. In case of flexible threshold, it is determined automatically based on the deviations of prior events and is adjusted dynamically during the course of processing events to allow for only a limited number of Partitioned Events 130 to become Novel Behavior Events 146.

Learning Module 140 and Evaluation Module 142 use a subset of models based on AutoEncoder Neural Networks. An autoencoder has two main parts: an encoder that maps the input into the code, and a decoder that maps the code to a reconstruction of the input. The model tries to minimize the loss in the reconstruction of the input compared to the input. As there are multiple fields in the input and the reconstruction, various loss functions can be used. One such function is a sum of the weighted difference in the reconstructed event and input event. As an example, if the input event has 3 fields with values 0.1, 0.2, 0.3 and the reconstructed event has values 0.11, 0.22, 0.33 respectively, and weights associated with the loss function for each field are w1, w2, w3. Then the calculated loss would be [w1(0.11−0.1)+w2(0.22−0.2)+w3(0.33−0.3)] or [0.01w1+0.02w2+0.03w3]. The model strives to minimize the average loss over all the events, usually passed to model. Adjusting these weights dynamically in an Autonomous Novel Behavior Detection apparatus is a novel technique as compared to using static weights or constant weight of 1.

Inside Novel Behavior Event Processing Module 150, Novel Behavior Events 146 are first processed by Novel Behavior Baseline Module 152 that evaluates Novel Behavior Events 146 for deviation from past Novel Behavior Events 146 utilizing neural networks (including Auto Encoders, Sparse Auto Encoders, Denoising Auto Encoders, Functional Models, Variational AutoEncoders, Sequential neural networks). After evaluating new Novel Behavior Events 146, Novel Behavior Baseline Module 152 trains on the same Novel Behavior Events 146 so that in future these match the baseline and are no longer Novel Behavior Events 146 of interest. These Novel Behavior Events 146 of interest are evaluated against Past Novel Behavior Events Database 156, and pre-existing Novel Behavior Events are filtered out. These events are scored by Novel Behavior Scoring Module 154, and the events with a score above a threshold (fixed or flexible, determined dynamically) are output as Novel Behaviors 160. Novel Behaviors 160 are one of the outputs of the Autonomous Novel Behavior Detection Apparatus 100.

Novel Behaviors 160 are further processed by Novel Behavior Clustering Module 170. Novel Behavior Clustering Module 170 clusters the novel behaviors 160 over a dynamic period of time across multiple feature dimensions. It projects the novel behavior event onto a multi-dimensional space where each feature of the Novel Behaviors 160 form a dimension. It identifies the dimension that provides the best summarization of the Novel Behaviors 160 on the basis of proximity, identicality and similarity of values in the fields. It clusters Novel Behaviors 160 further by picking additional dimensions incrementally. The Novel Behaviors 160 that are not close enough in the multi-dimensional, as described above, are not clustered together and are output as independent novel behaviors. The output of Novel Behavior Clustering Module 170 are the summarized Novel Behaviors that can be used by a user to get understanding of novel behaviors in their organization, investigate them further for detection and prevention of malicious attacks.

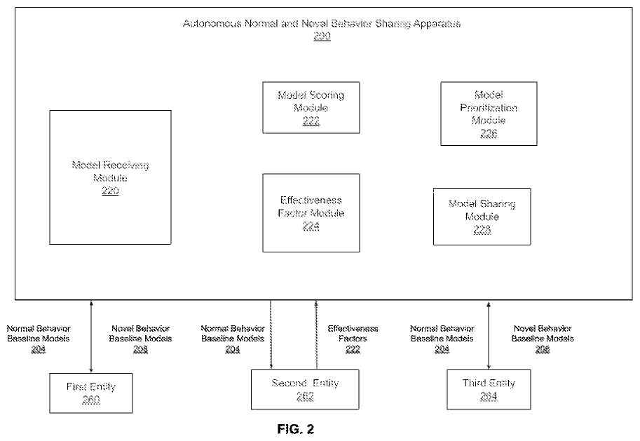

FIG. 2 illustrates an Autonomous Normal and Novel Behavior Sharing Apparatus 200 (hereinafter also referred to as “apparatus 200”), according to an example of the present disclosure. Referring to FIG. 2, the apparatus 200 is depicted as including a Model Receiving Module 220 to receive Normal Behavior Baseline Models 204 and Novel Behavior Baseline Models 208 from plurality of Entities (First Entity 262, Second Entity 264, Third Entity 266 etc.) The entities (First Entity 262, Second Entity 264, Third Entity 266 etc.) sharing the models share them from Autonomous Novel Detection Apparatus 100 or any such equivalent systems that utilize neural network models for learning and evaluation of Network Events 102, Application Events 104, User Events 106, Device Events 108.

Model Sharing Module 228 shares one or more of the models received by Model Receiving Module 220 with a subset of other entities. As an example, First Entity 260 may share a model that is received by Model Receiving Module 220. The model may get shared by Model Sharing Module 228 with Second Entity 262.

The entities receiving a model from Model Sharing Module 228 may compute the Effectiveness Factors for the received models based on the effectiveness of the model in the receiving entities' environments. The effectiveness may be based on the number or fraction of Network Events 102, Application Events 104, User Events 106, Device Events 108 identified as novel behavior events by received models. The effectiveness may further be affected by other factors, including percentage similarity of received models with the models trained on entity's own events or deviation of received models from the models trained on entity's own events. Effectiveness Factors can also be based on validation of the results influenced by models from Model Sharing Module 228 for an entity. The results influenced positively, as validated by the entity, increase the effectiveness factor. The results influenced negatively, as validated by the entity, decrease the effectiveness factor. Entities share these effectiveness factors 222 with Autonomous Normal and Novel Behavior Sharing Apparatus 200 through Effectiveness Factors Module 224.

Effectiveness Factors Module 224 normalizes the effectiveness scores based on multiple factors, including but not limited to the absolute values of the factors, comparison of the factors received by multiple entities, rating and importance of the submitting entity, and information regarding validation of results by the entity submitting the Effectiveness Factors 222. Effectiveness Factors Module 224 shares the normalized effectiveness factors with Model Scoring Module 222.

Model Scoring Module 222 scores the Normal Behavior Baseline Models 204 and Novel Behavior Baseline Models 208 shared by a plurality of entities based on Effectiveness Factors 222 received from entities that received and utilized these models. Model Scoring Module 222 also updates model scores based on other factors, including but not limited to rating and importance of the entities sharing the models.

Model Prioritization Module 226 uses information from Model Scoring Module 222 and Effectiveness Factors Module 224 to prioritize the models that need to be shared with different entities. Model Prioritization Module 226 may exclude sharing of certain models with an entity based on lower model scores, their effectiveness factors for the entity, entity's preferences and other choices. The frequency at which models and updates are shared with the entities are also determined by Model Prioritization Module 226 based on prioritization of a model for an entity. Model Prioritization Module 226 may also discontinue sharing of the previously shared models with an entity based on prioritization or entity's preferences.

Based on prioritization by Model Prioritization Module 226, corresponding models are shared by Model Sharing Module 228 with entities (First Entity 262, Second Entity 264, Third Entity 266 etc.) at a computed frequency. The frequency of sharing can be statically calculated or determined probabilistically over a range of values.

As an example, First Entity 260 may share a Normal Behavior Baseline Model (Norm1) and a Novel Behavior Baseline Model (Nov1). These models may get prioritized for Second Entity 262 and be shared with the Second Entity 262. Second Entity 262 may find Model Norm1 to be effective and Model Nov1 to be ineffective. It may share the Effectiveness Factors 222 corresponding to these models with Effectiveness Factors Module 224. Based on the normalized Effectiveness Factors from Effectiveness Factors Module 224 and additional context, Model Norm1 and Model Nov1 are scored by Model Scoring Module 222. Based on results from Effectiveness Factors Module 224 and Model Scoring Module 222, Model Prioritization Module 226 may chose to discontinue sharing of Model Nov1 with Second Entity 262 and increase the frequency of sharing Model Norm1 with Second Entity 262.

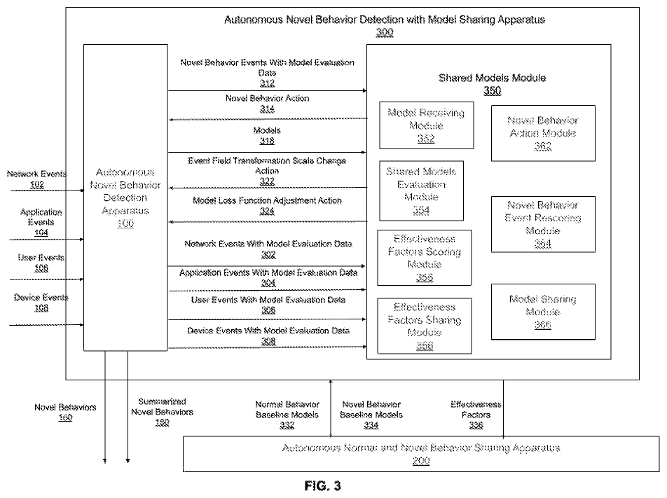

FIG. 3 illustrates an Autonomous Novel Behavior Detection with Model Sharing Apparatus 300 (hereinafter also referred to as “apparatus 300”), according to an example of the present disclosure.

Referring to FIG. 3, the apparatus 300 is depicted as including an apparatus 100 that receives Network Events 102, Application Events 104, User Events 106 and Device Events 108 to be analyzed by apparatus 100 and apparatus 300. Apparatus 100 evaluates the Network Events 102, Application Events 104, User Events 106 and Device Events 108 and enriches these events with model evaluation data. The model evaluation data includes information regarding the models that processed an event, results of evaluation and detailed information regarding the deviation of each field in the event as determined by the evaluating model. Apparatus 100 sends these enriched events as Network Events with Model Evaluation Data 302, Application Events with Model Evaluation Data 304, User Events with Model Evaluation Data 306, Device Events with Model Evaluation Data 308 and Novel Behavior Events With Model Evaluation Data 312 to Shared Models Module 350.

Network Events with Model Evaluation Data 302 contain all the information in Network Events 102. Additionally, Network Events with Model Evaluation Data 302 contain model evaluation data that includes information regarding the models that processed an event, results of evaluation and detailed information regarding the deviation of each field in the event as determined by the evaluating model.

Application Events with Model Evaluation Data 304 contain all the information in Application Events 104. Additionally, Application Events with Model Evaluation Data 304 contain model evaluation data that includes information regarding the models that processed an event, results of evaluation and detailed information regarding the deviation of each field in the event as determined by the evaluating model.

User Events with Model Evaluation Data 306 contain all the information in User Events 106. Additionally, User Events with Model Evaluation Data 306 contain model evaluation data that includes information regarding the models that processed an event, results of evaluation and detailed information regarding the deviation of each field in the event as determined by the evaluating model.

Device Events with Model Evaluation Data 308 contain all the information in Network Events 108. Additionally, Device Events with Model Evaluation Data 308 contain model evaluation data that includes information regarding the models that processed an event, results of evaluation and detailed information regarding the deviation of each field in the event as determined by the evaluating model.

Novel Behavior Events With Model Evaluation Data 312 contain all the information in Novel Behaviors 160. Additionally, Novel Behavior Events With Model Evaluation Data 312 contain model evaluation data that includes information regarding the models that processed an event, results of evaluation and detailed information regarding the deviation of each field in the event as determined by the evaluating model.

Shared Models Module 350 comprises of a Model Receiving Module 352, a Shared Models Evaluation Module 354, an Effectiveness Factors Scoring Module 356, an EffectiveNess Factors Sharing Module 358, a Novel Behavior Event Suppression Module 362, a Novel Behavior Event Rescoring Module 364, and a Model Sharing Module 366.

Model Receiving Module 350 receives Normal Behavior Baseline Models 332 and Novel Behavior Baseline Models 334 from Autonomous Normal and Novel Behavior Sharing Apparatus 200. Model Receiving Module 350 also receives Models 318 from apparatus 100. Models 318 include all the normal behavior baseline models from Learning Module 140 and Evaluation Module 142 as well as Novel Behavior Baseline Models from Novel Behavior Baseline Modules 152 of apparatus 100.

Model Receiving Module 350 sends received Normal Behavior Baseline Models 332 and Novel Behavior Baseline Models 334 from apparatus 200 to Shared Models Evaluation Module 354 that uses these models to evaluate Network Events with Model Evaluation Data 302, Application Events with Model Evaluation Data 304, User Events with Model Evaluation Data 306, Device Events with Model Evaluation Data 308 and Novel Behavior Events With Model Evaluation Data 312, received from apparatus 100.

Shared Models Evaluation Module 354 evaluates Network Events with Model Evaluation Data 302, Application Events with Model Evaluation Data 304, User Events with Model Evaluation Data 306, Device Events with Model Evaluation Data 308 using Normal Behavior Baseline Models 332.

On the basis of evaluation and determination that one or more of Network Events with Model Evaluation Data 302, Application Events with Model Evaluation Data 304, User Events with Model Evaluation Data 306, Device Events with Model Evaluation Data 308 were detected novel behavior events by apparatus 100 but not by a threshold number of Normal Behavior Baseline Models 332, Shared Models Evaluation Module 354 directs a Novel Behavior Action Module 362 to suppress one or more Novel Behavior Events With Model Evaluation Data 312. Novel Behavior Action Module 362 sends a Novel Behavior Action 314 to apparatus 100 to suppress the corresponding Novel Behaviors 160.

On the basis of evaluation and determination that one or more of Network Events with Model Evaluation Data 302, Application Events with Model Evaluation Data 304, User Events with Model Evaluation Data 306, Device Events with Model Evaluation Data 308 were detected novel behavior events by apparatus 100 and a threshold number of Normal Behavior Baseline Models 332, Shared Models Evaluation Module 354 directs a Novel Behavior Event Rescoring Module 364 to rescore one or more Novel Behavior Events With Model Evaluation Data 312. Novel Behavior Event Rescoring Module 364 sends a Novel Behavior Action 314 to apparatus 100 to rescore the Novel Behaviors 160 to the specified score in the Novel Behavior Action 314.

On the basis of evaluation and determination that a threshold or more number of models in apparatus 100 are detecting high number of novel behavior events that are not determined novel by Normal Behavior Baseline Models 332, Shared Models Evaluation Module 354 identifies a subset of fields with high deviation compared to deviation in the received models and directs a Novel Behavior Action Module 362 to send Event Field Transformation Scale Change Action 322 to apparatus 100. Event Field Transformation Scale Change Action 322 contains details regarding decrease in the scale of the specified fields when transforming the Network Events 102, Application Events 104, User Events 106 and Device Events 108 by Partitioning Module 120 of apparatus 100.

On the basis of evaluation and determination that a threshold or more number of models in apparatus 100 are detecting low number of novel behavior events that are determined novel by Normal Behavior Baseline Models 332, Shared Models Evaluation Module 354 identifies a subset of fields with low deviation compared to deviation in the received models and directs Novel Behavior Action Module 362 to send Event Field Transformation Scale Change Action 322 to apparatus 100. Event Field Transformation Scale Change Action 322 contains details regarding increase in the scale of the specified fields when transforming the Network Events 102, Application Events 104, User Events 106 and Device Events 108 by Partitioning Module 120 of apparatus 100.

On the basis of evaluation and determination that a model in apparatus 100 is detecting high number of novel behavior events that are not determined novel by Normal Behavior Baseline Models 332 and Novel Behavior Baseline Models 334, Shared Models Evaluation Module 354 determines the deviation of each field in the novel behavior event detected by models at an entity and identify a subset of fields with high deviation compared to deviation in the received models and directs a Novel Behavior Action Module 362 to send a Model Loss Function Adjustment Action 324 to apparatus 100. Model Loss Function Adjustment Action 324 contains details regarding decrease in the weights of the specified fields in the loss function used to determine the loss of field values in the reconstructed event by the model compared to original weights of the field values in determining novel behavior event by Learning Module 140 and Evaluation Module 142 of apparatus 100.

On the basis of evaluation and determination that a model in apparatus 100 is detecting low number of novel behavior events that are determined novel by Normal Behavior Baseline Models 332 and Novel Behavior Baseline Models 334, Shared Models Evaluation Module 354 determines the deviation of each field in the novel behavior event detected by models at an entity and identify a subset of fields with low deviation compared to deviation in the received models and directs a Novel Behavior Action Module 362 to send a Model Loss Function Adjustment Action 324 to apparatus 100. Model Loss Function Adjustment Action 324 contains details regarding increase in the weights of the specified fields in the loss function used to determine the loss of field values in the reconstructed event by the model compared to original weights of the field values in determining novel behavior event by Learning Module 140 and Evaluation Module 142 of apparatus 100.

Shared Models Evaluation Module 354 also evaluates Network Events with Model Evaluation Data 302, Application Events with Model Evaluation Data 304, User Events with Model Evaluation Data 306, Device Events with Model Evaluation Data 308 using Novel Behavior Baseline Models 334. On the basis of evaluation and determination that one or more of Network Events with Model Evaluation Data 302, Application Events with Model Evaluation Data 304, User Events with Model Evaluation Data 306, Device Events with Model Evaluation Data 308 are determined normal behavior events by one of the Novel Behavior Baseline Models 334, Shared Models Evaluation Module 354 directs a Novel Behavior Action Module 362 to generate a Novel Behavior Action 314 that directs apparatus 100 to create a Novel Behaviors 160. Novel Behavior Action 314 also contains all the details of the corresponding Network Events with Model Evaluation Data 302, Application Events with Model Evaluation Data 304, User Events with Model Evaluation Data 306 or Device Events with Model Evaluation Data 308 to be used by apparatus 100 in creation of Novel Behaviors 160.

### Effectiveness Factors Scoring Module 356 Determines Effectiveness of Received Normal Behavior

Baseline Models 332 and Novel Behavior Baseline Models 334 based on the effectiveness of these models in creation of a Novel Behavior Action 314. The models that influence creation of Novel Behavior Action 314 are more effective than the ones that do not lead to creation of Novel Behavior Action 314. Effectiveness Factors Sharing Module 356 shares the effectiveness factors determined by Effectiveness Factors Scoring Module 356 with apparatus 200 as Effectiveness Factors 336.

Model Sharing Module 366 shares Models 318 received from apparatus 100 with apparatus 300 as Normal Behavior Baseline Models 332 and Novel Behavior Baseline Models 334.

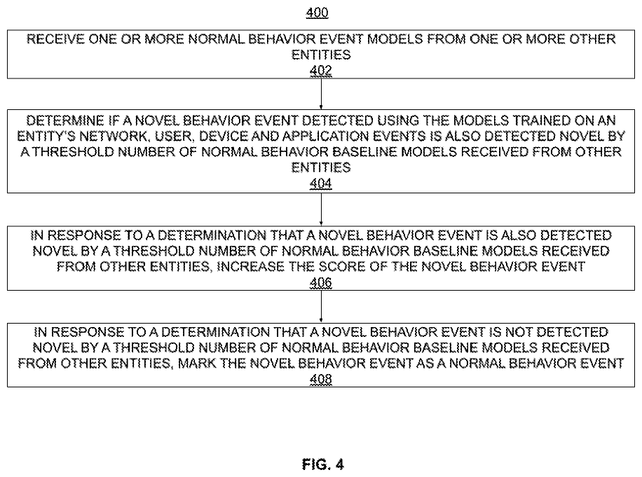

FIG. 4 illustrates flowchart of method 400 for determining suppression of a novel behavior event by Shared Models Evaluation Module 354 with reference to FIG. 3, corresponding to the example of the Autonomous Novel Behavior Detection with Model Sharing Apparatus 300 whose construction is described in detail above. The method 400 may be implemented on the Autonomous Novel Behavior Detection with Model Sharing Apparatus 300 with reference to FIG. 3 by way of example and not limitation. The methods 400 may be practiced in other apparatus.

Referring to FIG. 4, for method 400, at block 402, the method may include receiving one or more normal behavior event models from one or more other entities directly or through an Autonomous Normal and Novel Behavior Sharing Apparatus 200. At block 404, the method may include determining if a novel behavior event detected using the models trained on an entity's network, user, device and application events is also detected novel by a threshold number of normal behavior baseline models received from other entities. For example, referring to FIG. 3, Autonomous Novel Behavior Detection with Model Sharing Apparatus 300 may receive 10 normal behavior event models from apparatus 200. One or more Novel Behavior Events With Model Evaluation Data 312 may be evaluated by the 10 models received from apparatus 200. Threshold may be set to 4, and 5 of the models received from apparatus 200 may determine one or more Novel Behavior Events With Model Evaluation Data 312 to be novel behavior events.

In response to a determination that a novel behavior event is also detected novel by a threshold number of normal behavior baseline models received from other entities, at block 406, the method may include increasing the score of the novel behavior event.

According to an example, the threshold for this determination may be set to a static value. According to another example, the threshold for this determination may be set as a percentage of the total number of models evaluating the event. According to another example, the threshold for this determination may be calculated using a probabilistic distribution (normal, gaussian etc.)

In response to a determination that a novel behavior event is not detected novel by a threshold number of normal behavior baseline models received from other entities, at block 408, the method may include classifying the novel behavior event as a normal behavior event and hence suppressing the novel behavior event.

According to an example, referring to FIG. 3, Autonomous Novel Behavior Detection with Model Sharing Apparatus 300 may receive 10 normal behavior event models from apparatus 200. One of the Novel Behavior Events With Model Evaluation Data 312, Nov1, may be evaluated by the 10 models received from apparatus 200. Threshold may be set to 4, and 5 of the models received from apparatus 200 may determine Nov1 to be a novel behavior event. Nov1 may originally have a score of 6, and it's score may be increased to 7 as a result of the determination that a novel behavior event is also detected novel by a threshold number of normal behavior baseline models received from other entities.

According to an example, referring to FIG. 3, Autonomous Novel Behavior Detection with Model Sharing Apparatus 300 may receive 12 normal behavior event models from apparatus 200. One of the Novel Behavior Events With Model Evaluation Data 312, Nov2, may be evaluated by the 12 models received from apparatus 200. Threshold may be set to 5, and 2 of the models received from apparatus 200 may determine Nov2 to be a novel behavior event. Shared Models Evaluation Module 354, in apparatus 300, may direct a Novel Behavior Action Module 362 to suppress Nov2, as a result of the determination that a novel behavior event is not detected novel by a threshold number of normal behavior baseline models received from other entities. Novel Behavior Action Module 362 sends a Novel Behavior Action 314 to apparatus 100 to suppress Nov 2.

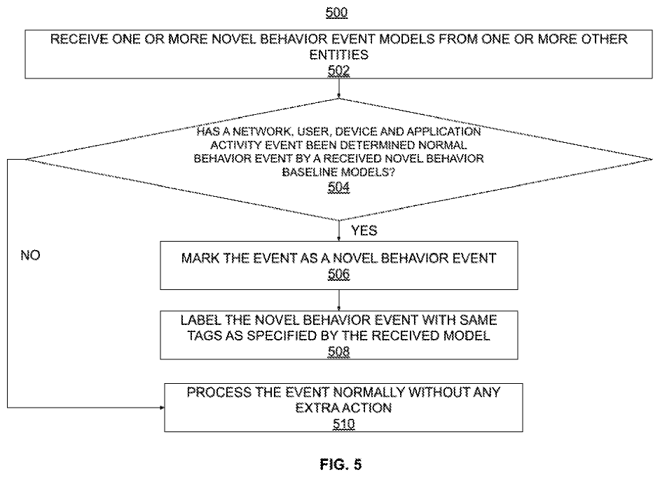

FIG. 5 illustrates flowchart of method 500 for determining detection of a novel behavior event by evaluating network, user, device and application activity events by novel behavior baseline models received from other entities in a Shared Models Evaluation Module 354 with reference to FIG. 3, corresponding to the example of the Autonomous Novel Behavior Detection with Model Sharing Apparatus 300 whose construction is described in detail above. The method 500 may be implemented on the Autonomous Novel Behavior Detection with Model Sharing Apparatus 300 with reference to FIG. 3 by way of example and not limitation. The methods 500 may be practiced in other apparatus.

Referring to FIG. 5, for method 500, at block 502, the method may include receiving one or more novel behavior event models from one or more other entities directly or through an Autonomous Normal and Novel Behavior Sharing Apparatus 200. At block 504, the method may include determining if one of the Network Events 102, Application Events 104, User Events 106 and Device Events 108 have been determined normal event by one or more of the Novel Behavior Baseline Models 334 received from apparatus 200 by Shared Models Evaluation Module 354. For example, referring to FIG. 3, Autonomous Novel Behavior Detection with Model Sharing Apparatus 300 may receive 10 novel behavior event models from apparatus 200. One of the Network Events 102, Application Events 104, User Events 106 and Device Events 108, Norm1, may be evaluated by the 10 novel behavior event models received from apparatus 200. 2 of the novel behavior event models received from apparatus 200 may determine Norm1 to be a normal event.

In response to a determination that one of the Network Events 102, Application Events 104, User Events 106 and Device Events 108 is determined to be a normal event by one or more of the Novel Behavior Baseline Models 334 received from apparatus 200 by Shared Models Evaluation Module 354, at block 506, the method may include marking the corresponding network, application, user or device event as a novel behavior event, and at block 508, the method may include adding tags to the corresponding network, application, user or device event from all of the Novel Behavior Baseline Models 334 that detected this event to be normal. For example, referring to FIG. 3, Autonomous Novel Behavior Detection with Model Sharing Apparatus 300 may receive 10 novel behavior event models from apparatus 200. One of the Network Events 102, Application Events 104, User Events 106 and Device Events 108, Norm1, may be evaluated by the 10 novel behavior event models received from apparatus 200. 2 of the novel behavior event models received from apparatus 200 may determine Norm1 to be a normal event. Norm1 will be marked as a novel behavior event with tags from all of the Novel Behavior Baseline Models 334 that detected this event to be normal.

According to an example, a threshold number of Novel Behavior Baseline Models 334 may be required to determine one of the Network Events 102, Application Events 104, User Events 106 and Device Events 108 to be a normal event for it to be marked as a novel behavior event.

According to an example, the score of the marked novel behavior event may be proportional to the number of models that determined the corresponding network, application, user or device event to be a normal event by Novel Behavior Baseline Models 334.

In response to a determination that one of the Network Events 102, Application Events 104, User Events 106 and Device Events 108 is not determined to be a normal event by one or more of the Novel Behavior Baseline Models 334 received from apparatus 200 by Shared Models Evaluation Module 354, at block 510, the method may include not determining the corresponding event to be a novel behavior event.

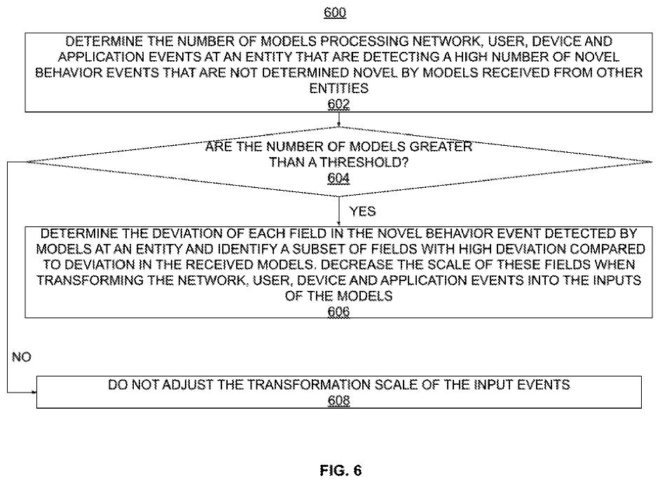

FIG. 6 illustrates flowchart of method 600 for determining decrease in the transformation scale of network, user, device and application activity events by partitioning module of apparatus 100, with reference to FIG. 1 and FIG. 3, corresponding to the example of the Autonomous Novel Behavior Detection with Model Sharing Apparatus 300 whose construction is described in detail above. The method 600 may be implemented on the Autonomous Novel Behavior Detection with Model Sharing Apparatus 300 with reference to FIG. 3 and apparatus 100 with reference to FIG. 1 by way of example and not limitation. The methods 600 may be practiced in other apparatus.

Referring to FIG. 6, for method 600, at block 602, the method may include determining, by Shared Models Evaluation Module 354, the number of models in apparatus 100 processing network, user, device and application events at an entity that are detecting a high number of novel behavior events that are not determined novel by Normal Behavior Baseline Models 332 received from apparatus 200.

For example, referring to FIG. 3, Autonomous Novel Behavior Detection with Model Sharing Apparatus 300 may receive 10 Normal Behavior Baseline Models 332 from apparatus 200. Shared Models Evaluation Module 354 may determine that 4 of the models in apparatus 100 may be detecting a high number of novel behavior events that are not determined novel by Normal Behavior Baseline Models 332 received from apparatus 200. According to an example, a model may be classified as detecting a high number of novel behavior events that are not determined novel by received models based on a static number or percentage of event difference between a model in apparatus 100 and received models from apparatus 200.

As an example, referring to FIG. 3, apparatus 300 may use Novel Behavior Baseline Models 334 instead of Normal Behavior Baseline Models 332. A network, user, application or device event is determined to be a novel behavior event if one or more of the Novel Behavior Baseline Models 334 determine it to be a normal event (i.e. resembling the Novel Behaviors modeled by Novel Behavior Baseline Models 334). A network, user, application or device event is determined to be a normal behavior event if a threshold number of the Novel Behavior Baseline Models 334 determine it to be a novel event (i.e. not resembling the Novel Behaviors modeled by Novel Behavior Baseline Models 334). As an example, apparatus 300, may use a combination of Normal Behavior Baseline Models 332 and Novel Behavior Baseline Models 334 in method 600.

At block 604, the method may include determining if the number of models in apparatus 100 processing network, user, device and application events at an entity that are detecting a high number of novel behavior events that are not determined novel by Normal Behavior Baseline Models 332 and Novel Behavior Baseline Models 334 received from apparatus 200 are greater than a threshold. The threshold may be defined statically, as a percentage of detected models to the total number of models or by probabilistics methods.

In response to a determination that there are threshold or more number of models in apparatus 100 processing network, user, device and application events at an entity that are detecting a high number of novel behavior events that are not determined novel by Normal Behavior Baseline Models 332 received from apparatus 200 by shared models evaluation module 354, at block 606, the method may include determining the deviation of each field in the novel behavior event detected by models in apparatus 100 and identifying a subset of fields with high deviation compared to deviation of corresponding events in the Normal Behavior Baseline Models 332 received from apparatus 200, and decreasing the scale of these fields when transforming the network, user, device and application events into the inputs of the models in apparatus 100. Apparatus 300. As an example, referring to FIG. 3, Shared Models Evaluation Module 354 identifies a subset of fields with high deviation compared to deviation in the received models and directs Novel Behavior Action Module 362 to send Event Field Transformation Scale Change Action 322 to apparatus 100. Event Field Transformation Scale Change Action 322 contains details regarding decrease in the scale of the specified fields when transforming the Network Events 102, Application Events 104, User Events 106 and Device Events 108 by Partitioning Module 120 of apparatus 100.

In response to a determination that there less than a threshold number of models in apparatus 100 processing network, user, device and application events at an entity that are detecting a high number of novel behavior events that are not determined novel by Normal Behavior Baseline Models 332 received from apparatus 200 by shared models evaluation module 354, at block 608, the method may include not to make any adjustment to the transformation scale of the input events in apparatus 100.

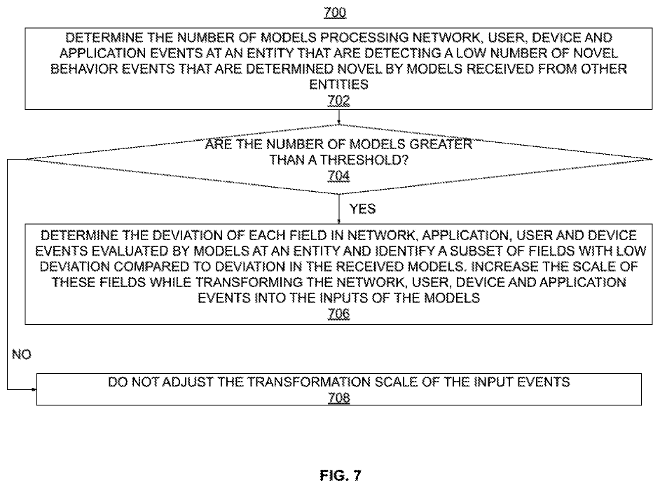

FIG. 7 illustrates flowchart of method 700 for determining increase in the transformation scale of network, user, device and application activity events by partitioning module of apparatus 100, with reference to FIG. 1 and FIG. 3, corresponding to the example of the Autonomous Novel Behavior Detection with Model Sharing Apparatus 300 whose construction is described in detail above. The method 700 may be implemented on the Autonomous Novel Behavior Detection with Model Sharing Apparatus 300 with reference to FIG. 3 and apparatus 100 with reference to FIG. 1 by way of example and not limitation. The methods 700 may be practiced in other apparatus.

Referring to FIG. 7, for method 700, at block 702, the method may include determining, by Shared Models Evaluation Module 354, the number of models in apparatus 100 processing network, user, device and application events at an entity that are detecting a low number of novel behavior events that are determined novel by Normal Behavior Baseline Models 332 received from apparatus 200.

For example, referring to FIG. 3, Autonomous Novel Behavior Detection with Model Sharing Apparatus 300 may receive 10 Normal Behavior Baseline Models 332 from apparatus 200. Shared Models Evaluation Module 354 may determine that 4 of the models in apparatus 100 may be detecting a low number of novel behavior events that are determined novel by Normal Behavior Baseline Models 332 received from apparatus 200. According to an example, a model may be classified as detecting a low number of novel behavior events that are determined novel by received models based on a static number or percentage of event difference between a received model from apparatus 200 and a model in apparatus 100.

As an example, referring to FIG. 3, apparatus 300 may use Novel Behavior Baseline Models 334 instead of Normal Behavior Baseline Models 332. A network, user, application or device event is determined to be a novel behavior event if one or more of the Novel Behavior Baseline Models 334 determine it to be a normal event (i.e. resembling the Novel Behaviors modeled by Novel Behavior Baseline Models 334). A network, user, application or device event is determined to be a normal behavior event if a threshold number of the Novel Behavior Baseline Models 334 determine it to be a novel event (i.e. not resembling the Novel Behaviors modeled by Novel Behavior Baseline Models 334). As an example, apparatus 300, may use a combination of Normal Behavior Baseline Models 332 and Novel Behavior Baseline Models 334 in method 700.

At block 704, the method may include determining if the number of models in apparatus 100 processing network, user, device and application events at an entity that are detecting a low number of novel behavior events that are determined novel by Normal Behavior Baseline Models 332 received from apparatus 200 are greater than a threshold. The threshold may be defined statically, as a percentage of detected models to the total number of models or by probabilistics methods.

In response to a determination that there are threshold or more number of models in apparatus 100 processing network, user, device and application events at an entity that are detecting a low number of novel behavior events that are determined novel by Normal Behavior Baseline Models 332 received from apparatus 200 by shared models evaluation module 354, at block 706, the method may include determining the deviation of each field in network, application, user and device events evaluated by models in apparatus 100 and identifying a subset of fields with low deviation compared to deviation of corresponding events in the Normal Behavior Baseline Models 332 received from apparatus 200, and increasing the scale of these fields when transforming the network, user, device and application events into the inputs of the models in apparatus 100. Apparatus 300. As an example, referring to FIG. 3, Shared Models Evaluation Module 354 identifies a subset of fields with low deviation compared to deviation in the received models and directs Novel Behavior Action Module 362 to send Event Field Transformation Scale Change Action 322 to apparatus 100. Event Field Transformation Scale Change Action 322 contains details regarding increase in the scale of the specified fields when transforming the Network Events 102, Application Events 104, User Events 106 and Device Events 108 by Partitioning Module 120 of apparatus 100.

In response to a determination that there less than a threshold number of models in apparatus 100 processing network, user, device and application events at an entity that are detecting a low number of novel behavior events that are determined novel by Normal Behavior Baseline Models 332 received from apparatus 200 by shared models evaluation module 354, at block 708, the method may include not to make any adjustment to the transformation scale of the input events in apparatus 100.

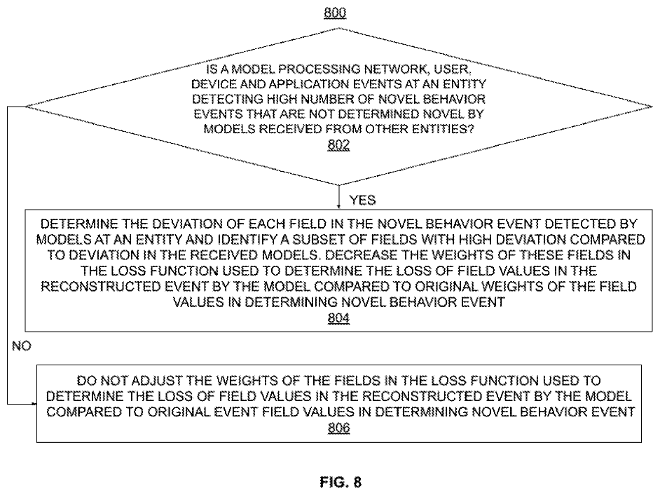

FIG. 8 illustrates flowchart of method 800 for determining the decrease in the weights of a subset of fields in the loss function used to calculate deviation of reconstructed network, user, device and application activity events from original network, user, device and application activity events in apparatus 100, with reference to FIG. 1 and FIG. 3, corresponding to the example of the Autonomous Novel Behavior Detection with Model Sharing Apparatus 300 whose construction is described in detail above. The method 800 may be implemented on the Autonomous Novel Behavior Detection with Model Sharing Apparatus 300 with reference to FIG. 3 and apparatus 100 with reference to FIG. 1 by way of example and not limitation. The methods 800 may be practiced in other apparatus.

Referring to FIG. 8, for method 800, at block 802, the method may include determining, by Shared Models Evaluation Module 354, if a model in apparatus 100 processing network, user, device and application events at an entity is detecting high number of novel behavior events that are not determined novel by Normal Behavior Baseline Models 332 received from apparatus 200.

For example, referring to FIG. 3, Autonomous Novel Behavior Detection with Model Sharing Apparatus 300 may receive 10 Normal Behavior Baseline Models 332 from apparatus 200. Shared Models Evaluation Module 354 may determine that a model in apparatus 100 may be detecting a high number of novel behavior events that are not determined novel by Normal Behavior Baseline Models 332 received from apparatus 200. According to an example, a model may be classified as detecting a high number of novel behavior events that are not determined novel by received models based on a static number or percentage of event difference between a model in apparatus 100 and received models from apparatus 200.

As an example, referring to FIG. 3, apparatus 300 may use Novel Behavior Baseline Models 334 instead of Normal Behavior Baseline Models 332. A network, user, application or device event is determined to be a novel behavior event if one or more of the Novel Behavior Baseline Models 334 determine it to be a normal event (i.e. resembling the Novel Behaviors modeled by Novel Behavior Baseline Models 334). A network, user, application or device event is determined to be a normal behavior event if a threshold number of the Novel Behavior Baseline Models 334 determine it to be a novel event (i.e. not resembling the Novel Behaviors modeled by Novel Behavior Baseline Models 334). As an example, apparatus 300, may use a combination of Normal Behavior Baseline Models 332 and Novel Behavior Baseline Models 334 in method 800.

In response to a determination, by Shared Models Evaluation Module 354, that a model in apparatus 100 processing network, user, device and application events at an entity is detecting high number of novel behavior events that are not determined novel by Normal Behavior Baseline Models 332 received from apparatus 200, at block 804, the method may include determining the deviation of each field in the novel behavior event detected by models at apparatus 100 and identifying a subset of fields with high deviation compared to deviation of corresponding events in the Normal Behavior Baseline Models 332 received from apparatus 200, and decreasing the weights of these fields in the loss function used to determine the loss of field values in the reconstructed event by the model compared to original weights of the field values in determining novel behavior event in apparatus 100. As an example, referring to FIG. 3, Shared Models Evaluation Module 354 identifies a subset of fields with high deviation compared to deviation of corresponding events in the Normal Behavior Baseline Models 332 received from apparatus 200, and directs Novel Behavior Action Module 362 to send Model Loss Function Adjustment Action 324 to apparatus 100. Model Loss Function Adjustment Action 324 contains details regarding decrease in the weights of the specified fields in the loss function used to determine the loss of field values in the reconstructed event by the model compared to original weights of the field values in determining novel behavior event by Learning Module 140 and Evaluation Module 142 of apparatus 100.

In response to a determination, by Shared Models Evaluation Module 354, that there is no model in apparatus 100 processing network, user, device and application events that is detecting high number of novel behavior events that are not determined novel by Normal Behavior Baseline Models 332 received from apparatus 200, at block 806, the method may include not adjusting the weights of the fields in the loss function used to determine the loss of field values in the reconstructed event by the model compared to original event field values in determining novel behavior event.

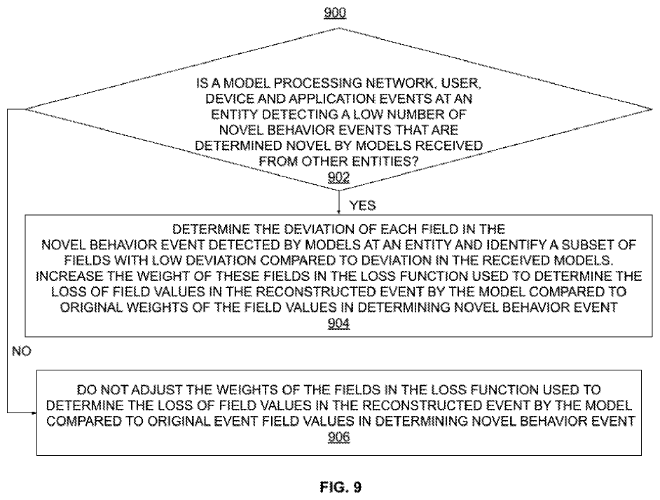

FIG. 9 illustrates flowchart of method 900 for determining the increase in the weights of a subset of fields in the loss function used to calculate deviation of reconstructed network, user, device and application activity events from original network, user, device and application activity events in apparatus 100, with reference to FIG. 1 and FIG. 3, corresponding to the example of the Autonomous Novel Behavior Detection with Model Sharing Apparatus 300 whose construction is described in detail above. The method 900 may be implemented on the Autonomous Novel Behavior Detection with Model Sharing Apparatus 300 with reference to FIG. 3 and apparatus 100 with reference to FIG. 1 by way of example and not limitation. The methods 900 may be practiced in other apparatus.

Referring to FIG. 9, for method 900, at block 902, the method may include determining, by Shared Models Evaluation Module 354, if a model in apparatus 100 processing network, user, device and application events at an entity is detecting a low number of novel behavior events that are determined novel by Normal Behavior Baseline Models 332 received from apparatus 200.

For example, referring to FIG. 3, Autonomous Novel Behavior Detection with Model Sharing Apparatus 300 may receive 10 Normal Behavior Baseline Models 332 from apparatus 200. Shared Models Evaluation Module 354 may determine that a model in apparatus 100 may be detecting a low number of novel behavior events that are determined novel by Normal Behavior Baseline Models 332 received from apparatus 200. According to an example, a model may be classified as detecting a low number of novel behavior events that are determined novel by received models based on a static number or percentage of event difference between models received from apparatus 200 and a model in apparatus 100.

As an example, referring to FIG. 3, apparatus 300 may use Novel Behavior Baseline Models 334 instead of Normal Behavior Baseline Models 332. A network, user, application or device event is determined to be a novel behavior event if one or more of the Novel Behavior Baseline Models 334 determine it to be a normal event (i.e. resembling the Novel Behaviors modeled by Novel Behavior Baseline Models 334). A network, user, application or device event is determined to be a normal behavior event if a threshold number of the Novel Behavior Baseline Models 334 determine it to be a novel event (i.e. not resembling the Novel Behaviors modeled by Novel Behavior Baseline Models 334). As an example, apparatus 300, may use a combination of Normal Behavior Baseline Models 332 and Novel Behavior Baseline Models 334 in method 900.

In response to a determination, by Shared Models Evaluation Module 354, that a model in apparatus 100 processing network, user, device and application events at an entity is detecting a low number of novel behavior events that are determined novel by Normal Behavior Baseline Models 332 received from apparatus 200, at block 904, the method may include determining the deviation of each field in the novel behavior event detected by models at apparatus 100 and identifying a subset of fields with low deviation compared to deviation of corresponding events in the Normal Behavior Baseline Models 332 received from apparatus 200, and increasing the weights of these fields in the loss function used to determine the loss of field values in the reconstructed event by the model compared to original weights of the field values in determining novel behavior event in apparatus 100. As an example, referring to FIG. 3, Shared Models Evaluation Module 354 identifies a subset of fields with low deviation compared to deviation of corresponding events in the Normal Behavior Baseline Models 332 received from apparatus 200, and directs Novel Behavior Action Module 362 to send Model Loss Function Adjustment Action 324 to apparatus 100. Model Loss Function Adjustment Action 324 contains details regarding increase in the weights of the specified fields in the loss function used to determine the loss of field values in the reconstructed event by the model compared to original weights of the field values in determining novel behavior event by Learning Module 140 and Evaluation Module 142 of apparatus 100.

In response to a determination, by Shared Models Evaluation Module 354, that there is no model in apparatus 100 processing network, user, device and application events that is detecting a low number of novel behavior events that are determined novel by Normal Behavior Baseline Models 332 received from apparatus 200, at block 906, the method may include not adjusting the weights of the fields in the loss function used to determine the loss of field values in the reconstructed event by the model compared to original event field values in determining novel behavior event.

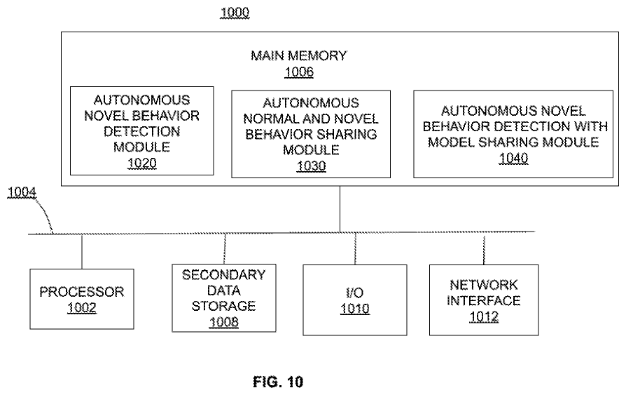

FIG. 10 shows a computer system 1000 that may be used with the examples described herein. The computer system 1000 may represent a generic platform that includes components that may be in a server or another computer system. The computer system 1000 may be used as a platform for apparatus 100, apparatus 200, and apparatus 300. The computer system 1000 may execute, by a processor (e.g., a single or multiple processors) or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 1000 may include a processor 1002 that may implement or execute machine readable instructions performing some or all of the methods, functions and other processes described herein. Commands and data from the processor 1002 may be communicated over a communication bus 1004. The computer system may also include a main memory 1006, such as a random access memory (RAM), where the machine readable instructions and data for the processor 1002 may reside during runtime, and a secondary data storage 1008, which may be non-volatile and stores machine readable instructions and data. Memory and data storage are examples of computer readable mediums. The main memory 1006 may include an autonomous novel behavior detection module 1020, an autonomous normal and novel behavior sharing module 1030 and an autonomous novel behavior detection with module sharing module 1040 including machine readable instructions residing in the main memory 1006 during runtime and executed by the processor 1002. The autonomous novel behavior detection module 1020 may include the modules of the apparatus 100 shown in FIG. 1, the autonomous normal and novel behavior sharing module 1030 may include modules of the apparatus 200 shown in FIG. 2 and the autonomous novel behavior detection with module sharing module 1040 may include modules of the apparatus 300 shown in FIG. 3.

The computer system 1000 may include an I/O device 1010, such as a keyboard, a mouse, a display, etc. The computer system may include a network interface 1012 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

1. A non-transitory computer readable medium having stored there on machine readable instructions to provide autonomous normal and novel behavior sharing platform, the machine readable instructions, when executed, cause at least one processor to: receive one or more novel behavior baseline models and one or more normal behavior baseline models from a first entity for sharing with a second entity and a subset of other entities; share the received models with the second entity and a subset of other entities; receive one or more novel behavior baseline models and one or more normal behavior baseline models from other entities for sharing with the first entity and a subset of other entities; share the received models with the first entity and subset of other entities; receive effectiveness factor of the shared models from the entities that received these models; score the models based on effectiveness factor received from a plurality of entities; prioritize sharing of the models based on their score.

2. The non-transitory computer readable medium of claim 1, wherein the machine readable instructions, when executed, further cause the at least one processor to: receive one or more novel behavior baseline models that are trained on the novel behavior events labelled with tags by a user from a first entity for sharing with a subset of other entities, and share the received models with a subset of other entities.

3. The non-transitory computer readable medium of claim 1, wherein the machine readable instructions, when executed, further cause the at least one processor to: discontinue sharing received models with a plurality of entities that provided low effectiveness score for these models.

4. A novel behavior detection system with model-sharing capability comprising: at least one processor; and a memory storing machine readable instructions that when executed by the at least one processor cause the at least one processor to: receive one or more novel behavior baseline models and one or more normal behavior baseline models by an entity 1 from an autonomous normal and novel behavior sharing platform or from another entity entity 2 directly; determine if a novel event detected using the models trained on entity 1 data is also detected novel by a threshold number of normal behavior baseline model received from other entities; and in response to a determination that the novel behavior event detected using the models trained on entity 1 data is also detected novel by a threshold number of normal behavior baseline model received from other entities, increase the score of the novel behavior event; and in response to a determination that the novel event detected using the models trained on entity 1 data is not detected novel by a threshold number of normal behavior baseline model received from other entities, suppress the novel behavior event and mark it as a normal behavior event; determine if a network, user, device and application activity event is determined normal behavior event by the received novel behavior baseline models; and in response to a determination that a network, user, device and application activity event is determined normal behavior event by the received novel behavior baseline models; mark the event as a novel behavior event; determine effectiveness factors of the received models based on the number of events affected by the received models; share the effectiveness factors of the received models with the autonomous normal and novel behavior sharing platform.

5. The method according to claim 4, wherein the novel behavior baseline model received by entity 1 was trained on the novel behavior events labelled with tags including suspicious or malicious by users from other entities.

6. The method according to claim 4, wherein detected normal behavior events by the received novel behavior baseline models by an entity, are labelled with the same tags as the received model that trained on the novel behavior events labelled with certain tags by users from other entities.

7. The method according to claim 4, wherein multiple hierarchical layers of entity's models, received normal event models and received novel behavior event models are used for filtering and accentuating novel behavior event results.

8. The non-transitory computer readable medium of claim 4, wherein the machine readable instructions, when executed, further cause the at least one processor to: determine the number of models processing network, user, device and application events at an entity that are detecting high number of novel behavior events that are not determined novel by models received from other entities; and in response to determination that number of such models are more than a threshold, determine the deviation of each field in the novel behavior event detected by models at an entity and identify a subset of fields with high deviation compared to deviation in the received models and decrease the scale of these fields when transforming the network, user, device and application events into the inputs of the models.

9. The method according to claim 6, wherein the threshold is determined by a random probability value using normal probability distribution function.

10. The non-transitory computer readable medium of claim 4, wherein the machine readable instructions, when executed, further cause the at least one processor to: determine the number of models processing network, user, device and application events at an entity that are detecting low number of novel behavior events that are determined novel by models received from other entities; and in response to determination that number of such models are more than a threshold, determine the deviation of each field in the novel behavior event detected by models at an entity and identify a subset of fields with low deviation compared to deviation in the received models and increase the scale of these fields when transforming the network, user, device and application events into the inputs of the models.

11. The method according to claim 8, wherein the threshold is determined by a random probability value using normal probability distribution function.

12. The non-transitory computer readable medium of claim 5, wherein the machine readable instructions, when executed, further cause the at least one processor to: determine if a model processing network, user, device and application events at an entity is detecting high number of novel behavior events that are not determined novel by models received from other entities; and in response to a determination that a model processing network, user, device and application events at an entity is detecting high number of novel behavior events that are not determined novel by models received from other entities, determine the deviation of each field in the novel behavior event detected by models at an entity and identify a subset of fields with high deviation compared to deviation in the received models and decrease the weight of these fields in the loss function used to determine the loss of field values in the reconstructed event by the model compared to original event field values in determining novel behavior event.

13. The non-transitory computer readable medium of claim 5, wherein the machine readable instructions, when executed, further cause the at least one processor to: determine if a model processing network, user, device and application events at an entity is detecting low number of novel behavior events that are determined novel by models received from other entities; and in response to a determination that a model processing network, user, device and application events at an entity is detecting low number of novel behavior events that are determined novel by models received from other entities, determine the deviation of each field in the novel behavior event detected by models at an entity and identify a subset of fields with low deviation compared to deviation in the received models and increase the weight of these fields in the loss function used to determine the loss of field values in the reconstructed event by the model compared to original event field values in determining novel behavior event.

14. A novel behavior detection apparatus with model-sharing capability comprising: at least one processor; and a memory storing machine readable instructions that when executed by the at least one processor cause the at least one processor to: receive one or more novel behavior baseline models and one or more normal behavior baseline models from a first entity for sharing with a second entity and a subset of other entities; share the received models with the second entity and a subset of other entities; receive one or more novel behavior baseline models and one or more normal behavior baseline models from other entities for sharing with the first entity and a subset of other entities; share the received models with the first entity and subset of other entities; receive effectiveness factor of the shared models from the entities that received these models; score the models based on effectiveness factor received from a plurality of entities; prioritize sharing of the models based on their score.
